(19) United States
(12) Patent Application Publication
(10) Pub. No.: US 2013/0017772 A1
(43) Pub. Date: Jan. 17, 2013

(54) FILLETING KNIFE

(71) Applicant: James H. SHAMBAUGH, Dillsburg, PA (US)

(72) Inventor: James H. SHAMBAUGH, Dillsburg, PA (US)

(73) Assignee: IUV2FISH LAKE ONTARIO, Dillsburg, PA (US)

(21) Appl. No.: 13/183,578

(22) Filed: Jul. 15, 2011

(51) Int. Cl. A22C 25/16

(52) U.S. Cl. 452/161

(57) ABSTRACT

A filleting knife is disclosed that includes an offset portion that raises the handle away from the plane of the blade. The length of the offset portion allows a user to cut along the plane of a surface without scraping or otherwise contacting the surface.

### FIELD OF THE INVENTION

The present invention is generally directed to a knife, and more particularly to a knife having a handle that is uplifted from the plane of the blade.

### BACKGROUND OF THE INVENTION

The fishing industry has produced a number of unique knives for filleting fish. These knives include a wide variety of configurations, sizes and designs. It is believed that there does not exist a filleting knife that makes the hand and arm motion and manipulation of a user easier during the filleting process, such that the user can easily, rapidly, and efficiently produce fillets.

Thus, a long felt need exits to design a filleting knife that allows a user to easily fillet a fish in a simple and efficient motion.

What is needed is a filleting knife that allows a user to fillet a fish by sweeping a knife blade in a horizontal motion while allowing the user's hand to move parallel to the motion of the blade in a plane above the plane of the blade.

### SUMMARY OF THE INVENTION

An aspect of the disclosure includes a filleting knife including a blade comprising a blade longitudinal axis; a handle having a top surface, a bottom surface, and a handle longitudinal axis; an offset portion connecting the blade to the handle. The offset portion separates the blade longitudinal axis from the handle longitudinal axis by a distance greater than about 1 inch.

It is an object of the invention to provide a filleting knife that allows for the rapid filleting of fish by providing the user with a bladed tool that can be grasped with a hand above the plane of the table or support surface while passing the blade of the knife through the fish.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 illustrates a perspective view of an exemplary embodiment of a filleting knife according to the invention.

FIG. 2 illustrates a top view of the filleting knife of FIG. 1.

FIG. 3 illustrates a side view of the filleting knife of FIG. 1.

FIG. 4 illustrates a partial rear bottom view of the filleting knife of FIG. 1.

FIG. 5 illustrates a perspective view of another exemplary embodiment of a filleting knife according to the invention.

### DETAILED DESCRIPTION OF THE INVENTION

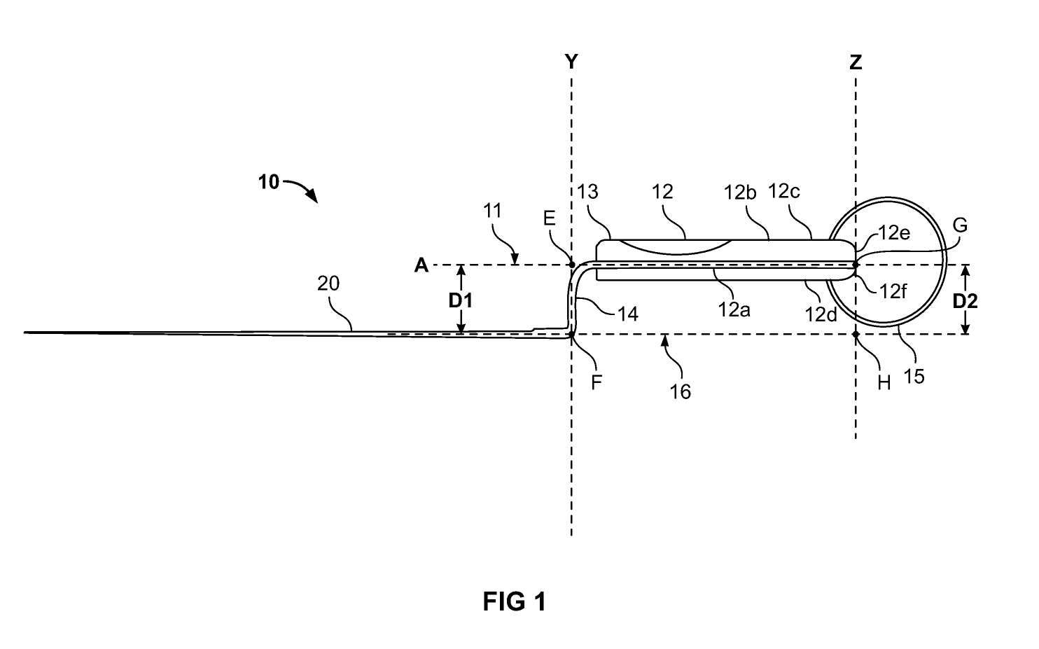

FIGS. 1, 2, 3 illustrate an exemplary embodiment of a filleting knife 10 according to the present invention. As can be seen in FIG. 1, the filleting knife 10 includes a handle 12, a substantially vertical drop or offset portion 14 extending from the handle 12, and a blade 20. The blade 20 extends in a forward direction “A” along the longitudinal axis 11 of the handle 12 from the substantially vertical drop or offset portion 14. In this exemplary embodiment, the filleting knife 10 includes an optional cord or lanyard 15, which is attached to the handle 12. The lanyard 15 may be used to attach the filleting knife 10 to a belt or other point of attachment (not shown).

The handle 12 includes tang portion 12a and a grip 12b. The handle 12 includes a top surface 12c and a bottom surface 12d. The tang portion 12a is in material connection with the offset portion 14. The grip 12b includes first and second grip portions 12e, 12f, respectively, that are attached to the tang portion 12a by fasteners 13. In another embodiment, the grip 12b may include one or more portions. In yet another embodiment, the grip 12b may be omitted, and the handle may be formed of only the tang 12a.

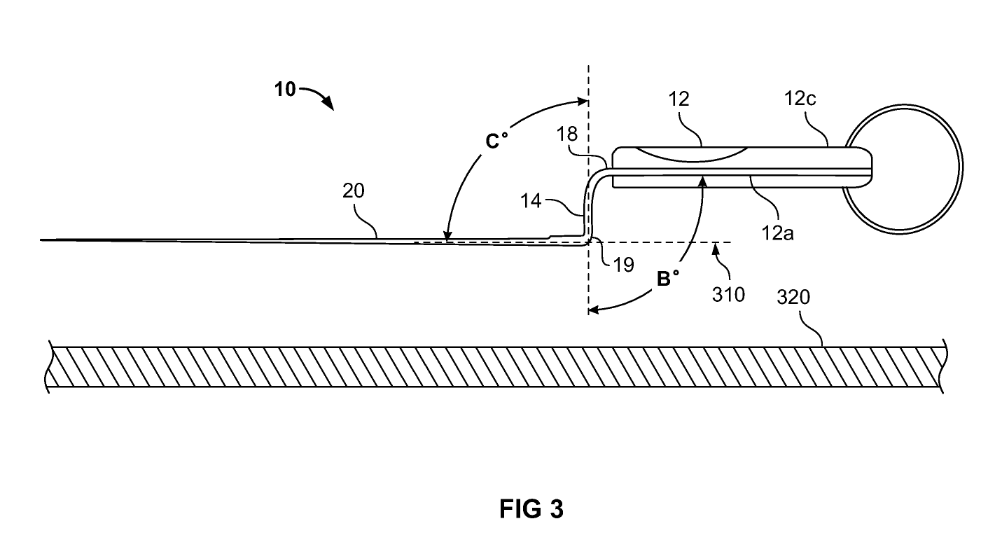

Referring to FIG. 3, the offset portion 14 extends below the handle 12. As used in this disclosure, the term “below” means vertically disposed beneath as referenced to the orientation of the filleting knife 10 when held in a operational position as shown in FIG. 1 with the major plane 310 of the blade positioned parallel to a horizontal cutting surface 320. The offset portion 14 includes a first transition portion 18 that connects the offset portion 14 to the tang portion 12a and a second transition portion 19 that connects the offset portion 14 to the blade 20.

The first transition portion 18 connects the offset portion 14 to the tang portion 12a at a first angle “B”. As further shown in FIG. 3, first angle “B” is a right angle or about 90°. In other words, as shown in FIGS. 1 and 3, the major axis of the offset portion 14 is the same as the vertical axis “Y”, which is perpendicular to the longitudinal axis 11 of the handle 12. In another embodiment, first angle “B” may be between about 90° and about 150°. In a further embodiment, first angle “B” may be between about 90° and about 120°. In yet a further embodiment, first angle “B” may be between about 90° and about 110.

The second transition portion 19 connects the offset portion 14 to the blade 20 at a second angle “C”. (see FIG. 3). As further shown in FIG. 3, second angle “C” is a right angle or about 90°. In other words, the major axis of the offset portion 14 is substantially coincident with the vertical axis “Y”, which is perpendicular to the longitudinal axis 16 of the blade 20. In another embodiment, second angle “C” may be between about 90° and about 150°. In a further embodiment, second angle “C” may be between about 90° and about 120°. In yet a further embodiment, second angle “C” may be between about 90° and about 110.

In other words, the transition portion 14 provides a transition from the horizontal, longitudinal axis 11 (FIG. 1) of the handle, to the horizontal, longitudinal axis 16 (FIG. 1) of the blade 20, such that in this embodiment, the longitudinal axis 11 of the handle 12 is substantially parallel to the longitudinal axis 16 of the blade 20 and separated by a distance D1 as measured from an intersection point E between longitudinal axis 11 of the handle and axis “Y” and an intersection point F between axis “Y” and longitudinal axis 16 of the blade 20. In an embodiment, the distance D1 is greater than about 1 inch. In another embodiment the distance D1 is greater than about 2 inches. In yet another embodiment, the distance D1 is greater than about 3 inches. In another embodiment, the distance D1 is between about 1 inch and about 3 inches. In a further embodiment, the distance D1 is between about 1 inch and about 2 inches.

It is to be understood that the term substantially parallel, such as in the context of the longitudinal axis 11 of handle 12 being substantially parallel to the longitudinal axis 16 of blade 20, is intended to mean that a distance D2 (FIG. 1) as measured between an intersection point G between an axis Z (that is parallel to axis Y) and axis A, and an intersection point H between axis Z and longitudinal axis 16 of blade 20 may deviate from distance D1 by about ½ inch. Point G coincides with an end of tang portion 12a that is opposite of first transition portion 18 (FIG. 3).

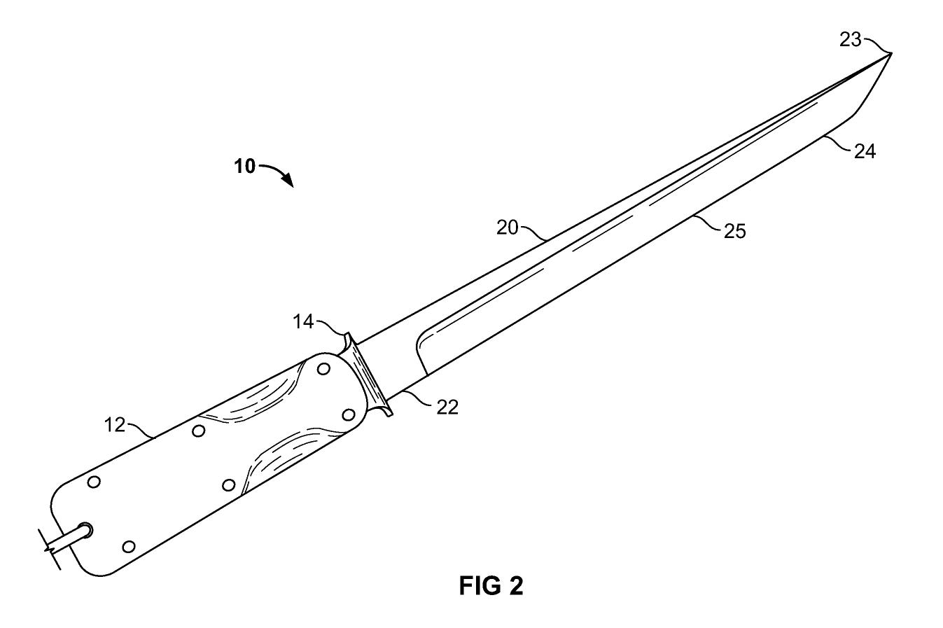

Referring to FIG. 2, the blade 20 further includes a cutting edge 24 disposed on a first side 25 of the blade 20. The blade 20 is tapered along the first side 25 from a rear end 22 to a tip 23. As can be appreciated by one of ordinary skill in the art, the amount of taper may vary.

In one embodiment, the length of blade 20 is between about 8 inches and about 12 inches. In another embodiment, the length of blade 20 is between about 9 inches and about 12 inches. In yet another embodiment, the length of blade 20 is between about 11 inches and about 12 inches. In a further embodiment, the length of blade 20 is about 12 inches. However in other embodiments, different ranges of lengths of less than 8 inches and greater than 12 inches may be used, depending upon the application of use, such as the size of the animal being filleted, and preference of the user.

As can be seen in FIG. 3, the offset portion 14 allows a user to grasp the handle 12 by wrapping the user's hand (not shown) around the handle 12, with the blade 20 proximate to the cutting surface 320. In such a manner, the blade 20 can be moved parallel and proximate to the cutting surface 320 without contacting the user's hand with the cutting surface 320.

Tang 12a, offset portion 14 and blade 20 may be manufactured from a single piece of material, such as metal, including, but not limited to steel, such as stainless steel. In other embodiments, at least blade 20 may be composed of a nonmetal material, including, but not limited to, a ceramic material, such as a nonmetal material having a hardened coating layer or a layer having hardened particulates contained in the layer, such as industrial diamond dust that is capable of holding a keen edge, a nonmetal material comprising a mixture of a hardening material capable of holding an edge without requiring an outer layer, and the like. In yet a further embodiment, tang 12a, offset portion 14 and blade 20 may be manufactured from a single piece of nonmetal material. In another embodiment, one or more of the tang 12a, offset portion 14, and blade 20 may be formed from separate pieces of material that are joined together. It is to be understood that in other embodiments, irrespective of the material of construction (i.e., metal or nonmetal), the handle may also be formed of the same material as the other portions of the knife. Stated another way, the knife may have a unitary construction.

As further shown in FIG. 1, grip 12b of handle 12 includes first grip portion 12e and second grip portion 12f. It is to be understood that grip portions 12e, 12f may be composed of a different material from tang 12a, although in another embodiment, one or more of grip portions 12e, 12f may be composed of the same material from which tang 12a is constructed. Grip portions 12e, 12f may be composed of any suitable material, including, but not limited to natural materials, such as animal horn or wood, man-made materials, such as micarta, a registered trademark owned by Industrial Laminates/Norplex, Inc. of Indiana, plastic, composites, and the like. It is also to be understood that grip portions 12e, 12f may be composed of materials that have a broad range of hardness or resiliency, such as in accordance with application of use, and/or “tactile feel”, as desired by the user. In one embodiment, first grip portion 12e may be composed of a material (or combination of materials) that is different from the material (or combination of materials) of second grip portion 12f, although in another embodiment, the grip portions may be composed of the same material(s).

It will be readily recognized that the blade 20 may include blades having various types of lengths, curvatures, shapes or cutting edges. An important consideration is that the offset portion 14 separates the longitudinal axis 16 of the blade 20 from the bottom surface of the handle 12 by a minimum separation distance D1 of more than about 1 inch. The minimum separation distance D1 allows the user to fillet a fish easily by moving the blade 20 along the backbone of the fish.

The knife 10 shown in FIGS. 1-3 may be referred to as a right handed embodiment. A fish would be positioned in front of the user sideways or transverse of the forward facing user position (from the left to the right as seen by the user, i.e., the head of the fish would be positioned to the left of the user, and the tail of the fish would be positioned toward the right of the user). The minimum separation distance D1 allows the user's right hand to remain above the cutting surface 320 (FIG. 3) as the user holds the knife 10 with the blade 20 passing through the fish in a left to right motion.

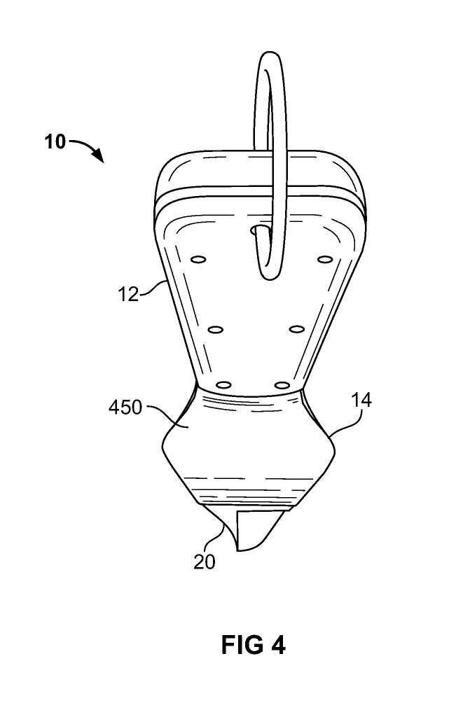

As can be appreciated by one in the art, the offset portion 14 also prevents the user's hand from slipping from the handle 12 in a forward direction towards the blade 20. As can be seen most clearly in FIG. 4, the offset portion 14 further includes protrusions or tabs 450 extending outwardly from offset portion 14 in a direction that is substantially perpendicular to longitudinal axis 11 of handle 12 in order to assist in preventing the user's hand from slipping onto the blade 20.

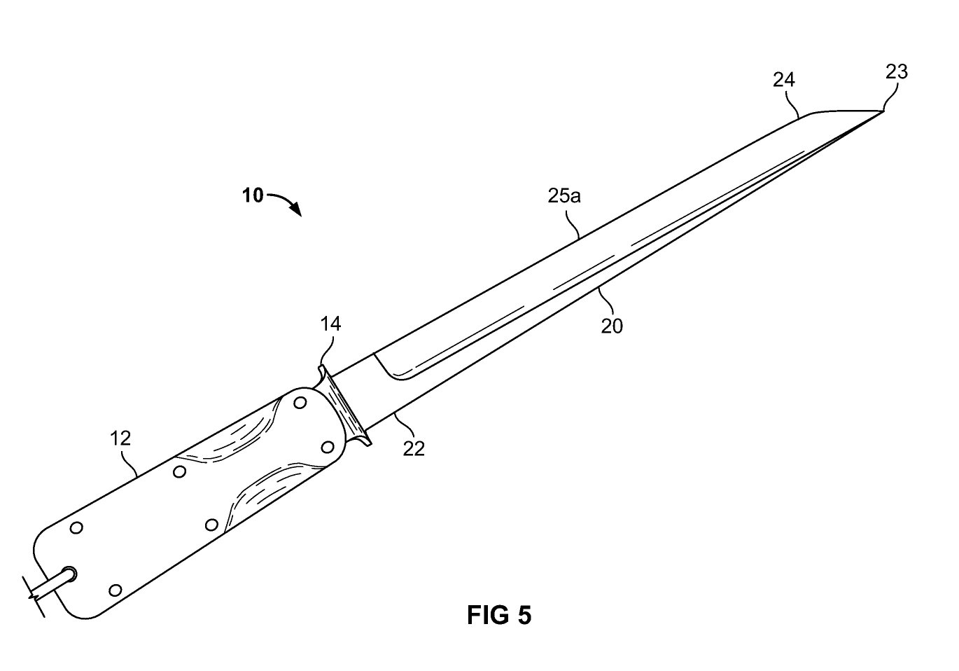

FIG. 5 illustrates a left hand embodiment of the knife 10. As can be seen in FIG. 5, the cutting edge 24 disposed on a second side 25a of the blade 20. In such a manner, a fish would be positioned in front of the user in an orientation sideways or transverse of the forward facing user position (from the right to the left as seen by the user, i.e., the head of the fish would be positioned to the right of the user, and the tail of the fish would be positioned toward the left of the user). The minimum separation distance D1 allows the user's left hand to remain above the cutting surface 320 (FIG. 3) as the user holds the knife 10 with the blade 20 passing through the fish in a right to left motion.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A filleting knife, comprising
a planar blade comprising a blade longitudinal axis;
a handle having a top surface, a bottom surface, and a handle longitudinal axis between the top surface and the bottom surface, the handle longitudinal axis extending through a planar tang portion;
an offset portion having a planar first surface, the offset portion connecting the blade to the handle, the first surface extending laterally from the handle, the offset portion having protrusions extending along the planar first surface; and
wherein the offset portion separates the blade longitudinal axis from the handle longitudinal axis and the tang portion by a distance greater than about 1 inch, the tang portion and the blade being non-coplanar.

2. The filleting knife of claim 1, wherein the handle longitudinal axis and the blade longitudinal axis are substantially parallel to each other.

3. The filleting knife of claim 1, wherein the offset portion attaches to the handle at a first angle between about 90° and about 150°.

4. The filleting knife of claim 3, wherein the first angle is between about 90° and about 120°.

5. The filleting knife of claim 3, wherein the first angle is between about 90° and about 110°.

6. The filleting knife of claim 3, wherein the first angle is about 90°.

7. The filleting knife of claim 1, wherein the offset portion attaches to the blade at a second angle between about 90° and about 150°.

8. The filleting knife of claim 7, wherein the second angle is between about 90° and about 120°.

9. The filleting knife of claim 7, wherein the second angle is between about 90° and about 110°.

10. The filleting knife of claim 7, wherein the second angle is about 90°.

11. The filleting knife of claim 1, wherein the offset portion is between about 1 inch and about 3 inches in length.

12. The filleting knife of claim 1, wherein the offset portion is between about 1 inch and about 2 inches in length.

13. (canceled)

14. The filleting knife of claim 5, wherein the handle further comprises a grip attached to the tang portion.

15. The filleting knife of claim 5, wherein the blade, the offset portion and the tang portion is formed of a single piece of material.

16. The filleting knife of claim 15, wherein the material is steel.

17. The filleting knife of claim 15, wherein the metal is stainless steel.

18. The filleting knife of claim 1, wherein a length of the blade is between about 8 inches and about 12 inches.

19. The filleting knife of claim 18, wherein the blade length is between about 9 inches and about 12 inches.

20. (canceled)
